(19) United States
(12) Patent Application Publication
(10) Pub. No.: US 2004/0231507 A1
(43) Pub. Date: Nov. 25, 2004

(54) Pressure generator

(75) Inventors: Yukihiro Miyashita, Tokyo (JP); Makoto Shinozaki, Tokyo (JP); Koji Saito, Tokyo (JP); Atsuo Kamimura, Tokyo (JP)

Correspondence Address: McCormick Paulding & Huber, CityPlace II, 185 Asylum Street, Hartford, CT, 06103, US

(73) Assignee: Koganei Corporation, Tokyo (JP)

(21) Appl. No.: 10/487,299

(22) PCT Filed: Sep. 27, 2002
(86) PCT No.: PCT/JP02/10068

(30) Foreign Application Priority Data
Sep. 28, 2001 (JP) 2001-299866

(51) Int. Cl. F15B 11/08

(52) U.S. Cl. 91/468

(57) ABSTRACT

A piston is axially and reciprocatably accommodated in a cylinder, and a piston rod, fixed to the piston, penetrates a rod cover to protrude to the outside. Negative pressure supply paths, connected between expansion-contraction chambers and operation ports, are provided with negative pressure check valves allowing flow of air toward the expansion-contraction chambers and blocking reverse flow thereto. Exhaust channels, communicating with the expansion-contraction chambers and the outside, are provided with exhaust check valves allowing flow from the expansion-contraction chambers to the outside and blocking reverse flow thereto. The respective negative pressure supply paths come to a vacuum state due to the reciprocating of the piston.

### TECHNICAL FIELD OF THE INVENTION

The present invention relates to a pressure generating device for generating pulsed negative or positive pressure air, for example, a pressure generating device, which generates positive or negative pressure air for posture-controlling and positioning parts in a conveyor that conveys the small and light parts such as semiconductor chips, condensers and resistors, etc.

### BACKGROUND OF THE INVENTION

When small and light parts such as semiconductor chips, condensers or resistors are mounted on a mounting substrate or test board, a chip mounter may convey them to the mounting substrate or test board from a part supplying portion. In the case where the relatively small parts are to be mounted, they are disposed in the part-supplying portion in the state of being housed in a tape feeder or bulk feeder. The tape feeder mounts the parts on a tape per a determined space by conveying the tape and sending out the parts. Also, the bulk feeder conveys the parts from a part-accommodating portion so as to be linearly arranged on a guide rail, and sends out the parts from the tip of the guide rail.

In the tape feeder, since empty tapes are left after the parts was pulled out, the disposing of the empty tapes as wastes is required. In contrast, the bulk feeder has the advantage that no wastes are generated. However, in order to pull out the parts using the bulk feeder, it is required to position the parts at the location of a port for pulling out the guide rail in the bulk feeder. In order to position each of the parts at a determined location in the state of a determined posture, attempts have been made to use a vacuum to position each part at the determined location on the guide rail.

A vacuum can be generated by a vacuum pump or an ejector as described in pages 450-451 of “Hydraulic Manual” published by Ohmsha Co. Ltd on Feb. 25, 1989. However, if a vacuum pump is incorporated into the bulk feeder or the like, the feeder itself will become large. Further, in order to use the ejector to generate a vacuum, it is required to always supply compressed air to a diffuser from a nozzle. Accordingly, since a part-conveying device must be provided with an air-pressure generating source such as a compressor etc, the conveying device will become large.

For example, in the case of suction-attaching the parts by a vacuum in order to posture-control and position the parts conveyed to a predetermined conveying port by the bulk feeder, since the parts are always being suction-attached by a vacuum, the parts cannot be easily raised at the time of raising the parts by a conveying head from the part-supplying portion, which is formed by the bulk feeder, to the mounting substrate. Thereat, it has been found that when pulsed negative pressure air is supplied in order to suction-attaching the parts to the bulk feeder, the suction-attachment and the suction-attachment release of the parts are instantaneously repeated, whereby the positioning of the parts can be certainly performed and the parts can be certainly raised by the conveying head when the suction-attachment of them is released. It has been also found that even when pulsed compressed air is supplied in order to convey the parts, the positioning of the parts can be certainly performed similarly.

However, in order to supply, in a pulse shape, the negative pressure air generated by the vacuum pump or ejector or the positive pressure air generated by the compressor, it is necessary to provide a vacuum path or positive pressure path with an electromagnetic valve for opening and closing the path.

An object of the present invention is to provide a compact pressure generating device for generating positive or negative pressure air.

Another object of this invention is to provide a compact pressure generating device for generating pulsed positive or negative pressure air.

Another object of the present invention is to provide a pressure generating device, which, in conveying compact and light parts along a conveying member, positions the parts at the predetermined location of the conveying member by positive or negative pressure air so that the head one of the positioned parts can be certainly pulled out from the conveying member.

### DISCLOSURE OF THE INVENTION

A pressure generating device according to the present invention comprises: a cylinder for accommodating axially and reciprocatably a piston fixed to a piston rod; a driving means linked to said piston rod and reciprocating-driving said piston axially; a pressure supply path connecting a expansion-contraction chamber formed in said cylinder and an operation port to which positive pressure or negative pressure air is supplied; a release check valve provided in said pressure supply path and communicating with said operation port and said expansion-contraction chamber through said pressure supply path when said expansion-contraction chamber expands and contracts depending on the reciprocating of said piston; and an auxiliary check valve provided in an auxiliary channel connected to said pressure supply path, and closing said auxiliary channel when said release check valve opens said pressure supply path, and opening said auxiliary channel when said pressure supply path is closed, wherein said expansion-contraction chamber is expanded by said piston to supply the positive pressure or negative pressure air to said operation port.

The pressure generating device according to the present invention further comprises: a first release check valve provided in a first pressure supply path connected to said expansion-contraction chamber in one side of said piston; a first auxiliary check valve provided in a first auxiliary channel connected to said first pressure supply path; a second release check valve provided in a second pressure supply path connected to said expansion-contraction chamber in the other side of said piston; and a second auxiliary check valve provided in a second auxiliary channel connected to said second pressure supply path, wherein the positive pressure or negative pressure air is alternately supplied, by the reciprocating of said piston, to each of two said operation ports to which said pressure supply path is connected.

In the pressure generating device according to the present invention, said pressure supply path is connected to said operation port formed in a part-conveying portion for conveying a part.

In the pressure generating device according to the present invention, there are provided, away from the reciprocating direction of said piston, a first check valve assembly including said first release check valve and said first auxiliary check valve, and a second check valve assembly including said second release check valve and said second auxiliary check valve.

In the present invention, by reciprocating linearly the piston incorporated in the cylinder, positive pressure air or negative pressure air can be generated using a compact device. Since the positive pressure air or negative pressure air is generated by the reciprocating of the piston, it is possible to: generate the positive pressure or negative pressure air at the time of one of the advance and back of the piston; stop generating the positive pressure or negative pressure air at the time of the other; and repeat the supply and the supply-stop of the positive pressure or negative pressure air to generate its pulse by using not an electromagnetic valve etc. but a simple and compact device. Further, by making close the distance between the expansion-contraction chamber and the check valve, a space through which air flows can be made small, whereby there is improved a high-speed response property of the positive pressure air or negative pressure air generated in a pulse shape. By supplying pulsed compressed air or negative pressure air to the operation port, which is formed on the part-conveying portion, the part can be pulled out from the part-conveying portion after being stopped to position at the part-conveying portion for a predetermined interval of time.

### BRIEF DESCRIPTION OF THE DRAWINGS

FIG. 1 is a schematic diagram of a pressure generating device which is an embodiment of the present invention.

FIG. 2 is a schematic diagram of a pressure generating device which is another embodiment of the present invention.

FIG. 3 is a schematic diagram of a pressure generating device which is another embodiment of the present invention.

FIG. 4A is a plan view of the pressure generating device shown in FIG. 1.

FIG. 4B is a cross-sectional view of FIG. 4A.

FIG. 5 is an enlarged cross-sectional view of the check valve assembly shown in FIG. 4.

FIG. 6 is a cross-sectional view of a modified example of the check valve assembly.

FIG. 7 is a cross-sectional view of another modified example of the check valve assembly.

FIG. 8A is a plan view showing a modified example of the pressure generating device.

FIG. 8B is a cross-sectional view of FIG. 8A.

FIG. 9 is a front view of another modified example of the pressure generating device.

FIG. 10 is a plan view of yet another modified example of the pressure generating device.

FIG. 11 is a front view of FIG. 10.

FIG. 12 is a left-side view of FIG. 11.

FIG. 13 is a right-side view of FIG. 11.

FIG. 14 is a cross-sectional view of FIG. 10.

### BEST MODE FOR CARRYING OUT THE INVENTION

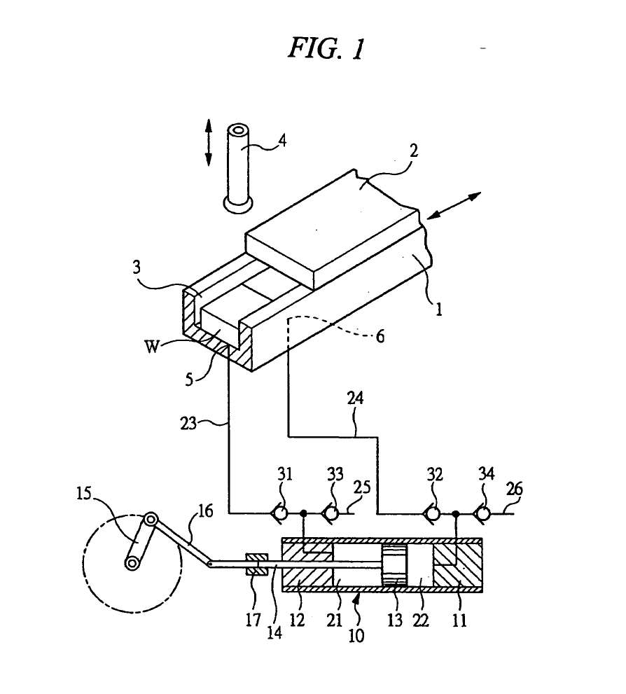

A pressure generating device shown in FIG. 1 is applied to a part-conveying device for conveying and supplying parts such as semiconductor chips etc. to a mounting substrate not shown from a part-supplying portion formed by a bulk feeder so that the parts may be positioned at a predetermined location by supplying negative pressure air to the part-conveying device and be pulled out from the head one of them to the outside. Namely, this pressure generating device is applied as one for negative pressure generation.

FIG. 1 shows a part-conveying port of the bulk feeder, and a part W is aligned and conveyed along a guide rail 1. The guide rail 1 is provided with an open-close shutter 2 linearly reciprocatable as shown by the arrow, and the part-conveying port 3 is opened and closed by this shutter 2. With the part-conveying port 3 being opened by the shutter 2, a suction-attachment member 4 provided in a conveyor head not shown moves downward, and the part W is suction-attached by the suction-attachment member 4 and ascends and is horizontally conveyed to the predetermined installing location for installing a mounting substrate or the like. After being conveyed to the predetermined location, the part W is mounted on an installed member such as a mounting substrate etc. by moving downward the suction-attachment member 4.

In order to position, at a predetermined location of the part-conveying port 3, the part W conveyed along the guide rail 1 and to set it to have a predetermined posture, two operation ports 5 and 6 for supplying negative pressure air, i.e. vacuum, are formed at the bottom surface of the guide rail 1. A pressure generating device for supplying the negative pressure air to these ports includes a cylinder 10 which has a head cover 11 at an end and a rod cover 12 at the other end. A piston 13 reciprocatable axially is accommodated in the cylinder 10.

The piston rod 14 fixed to the piston 13 penetrates through the rod cover 12 and protrudes to the outside, and the piston rod 14 is connected through a link mechanism 16 and a connecting screw member 17 to a rotating member 15, which is rotation-driven by a not-shown electric motor as a driving means. By such configuration, the rotation of the electric motor is converted through the link mechanism 16 to the axial reciprocation of the piston rod 14, whereby the piston 13 reciprocates linearly. However, the cause of the reciprocation of the piston 13 is not limited to the use of the electric motor, and may be that of other driving means such as an air pressure cylinder etc.

In the cylinder 10, expansion-contraction chambers 21 and 22 are respectively formed on both sides of the piston 13. When the piston 13 is moved leftward in FIG. 1, the expansion-contraction chamber 21 contracts, and when it moves rightward, the expansion-contraction chamber 21 expands. Conversely, when the piston 13 is moved leftward in FIG. 1, the expansion-contraction chamber 22 expands, and when it moves rightward, the expansion-contraction chamber 21 contracts. A negative pressure supply path 23 is connected as a pressure supply path between the expansion-contraction chamber 21 and the bottom surface of the guide rail 1, and this negative pressure supply path 23 communicates with the operation port 5, which is formed in the bottom surface of the guide rail 1. A negative pressure supply path 24 is connected as a pressure supply path between the expansion-contraction chamber 22 and the bottom surface of the guide rail 1, and this negative pressure supply path 24 communicates with the operation port 6, which is formed in the bottom surface of the guide rail 1.

An exhaust path 25 as an auxiliary flow path is connected to the negative pressure supply path 23, and this exhaust path 25 communicates with the expansion-contraction chamber 21 via the negative pressure supply path 23. An exhaust path 26 as an auxiliary flow path is connected to the negative pressure supply path 24, and this exhaust path 26 communicates with the expansion-contraction chamber 22 via the negative pressure supply path 24.

Negative pressure check valves 31 and 32, which allow flow of air toward the expansion-contraction chambers 21 and 22 from the operating ports 5 and 6 and prevent reverse flow thereto, are provided as release check valves in the negative pressure supply paths 23 and 24, respectively. That is, when the expansion-contraction chamber 21 expands depending on the reciprocation of the piston 13, the negative pressure check valve 31 opens the negative pressure supply path 23 and then the operation port 5 and the expansion-contraction chamber 21 communicate with each other via the negative pressure supply path 23. When it contracts, the negative pressure supply path 23 is closed by the negative pressure check valve 31. Further, when the expansion-contraction chamber 22 expands depending on the reciprocation of the piston 13, the negative pressure check valve 32 opens the negative pressure supply path 24 and then the operation port 6 and the expansion-contraction chamber 22 communicate with each other via this negative pressure supply path 24. When it contracts, the negative pressure supply path 24 is closed by the negative pressure check valves 32.

Exhaust check valves 33 and 34, which allow flow of air from the expansion-contraction chambers 21 and 22 to the outside and prevent reverse flow thereto, are provided as auxiliary check valves in exhaust channels 25 and 26, respectively. That is, the exhaust check valve 33 closes the exhaust path 25 when the negative pressure check valve 31 opens the negative pressure supply path 23, and it opens the exhaust channel 25 when the negative pressure check valve 31 closes the negative pressure supply path 23. Further, the exhaust check valve 34 closes the exhaust channel 26 when the negative pressure check valve 32 opens the negative pressure supply path 24, and it opens the exhaust channel 26 when the negative pressure check valve 32 closes the negative pressure supply path 24.

Thus, when the piston 13 is moved rightward in FIG. 1 and the expansion-contraction chamber 21 expands, the negative pressure check valve 31 is opened and the negative pressure supply path 23 comes to a negative pressure air state, whereby negative pressure air is supplied to the operation port 5. Meanwhile, when it is moved leftward, the negative pressure check valve 31 is closed and the exhaust check valve 33 is opened, whereby the exhaust channel 25 communicates with the outside to discharge the air in the expansion-contraction chamber 21 into the outside.

Similarly, when the piston 13 is moved leftward in FIG. 1 and the expansion-contraction chamber 22 expands, the negative pressure check valve 32 is opened and the negative pressure supply path 24 comes to a negative pressure air state, whereby negative pressure air is supplied to the operation port 6. Meanwhile, when it is moved rightward, the negative pressure check valve 32 is closed and the exhaust check valve 34 is opened, whereby the exhaust channel 26 communicates with the outside to discharge the air in the expansion-contraction chamber 22 into the outside. Namely, this pressure generation device is applied as a positive pressure air generation device.

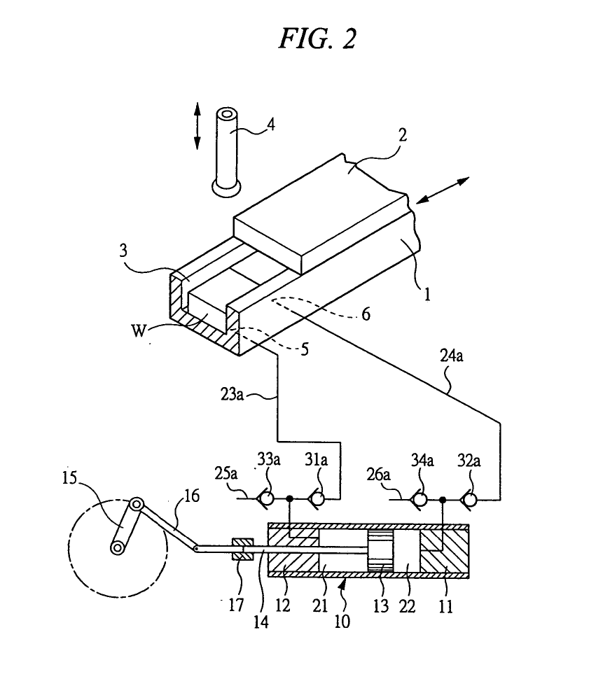

FIG. 2 is a schematic diagram of the pressure generating device which is another embodiment of the pressure invention. This pressure generating device is applied to the same part-conveying device as that shown in FIG. 1 so that, by supplying positive pressure air to the part-conveying device, parts can be positioned at a predetermined location and be pulled out from the head one of them to the outside.

In FIG. 2, members common to those shown in FIG. 1 are denoted by the same reference numbers. In this case, the operation ports 5 and 6 is opened in the side surface of the guide rail 1 and, by spraying the part W with positive pressure air therefrom, the part W is positioned at the predetermined location in the guide rail 1.

A positive pressure supply path 23a as a pressure supply path is connected between the operation port 5 and the expansion-contraction chamber 21, and a positive pressure supply path 24a as a pressure supply path is connected between the operation port 6 and the expansion-contraction chamber 22. Positive pressure check valves 31a and 32a, which, when the expansion-contraction chambers 21 and 22 contract, open the positive pressure supply paths 23a and 24a to supply positive pressure air to the operation ports 5 and 6, are provided in the positive pressure supply paths 23a and 24a, respectively.

Meanwhile, in external air guide channels 25a and 26a as auxiliary channels, which are connected to the positive pressure supply paths 23a and 24a, there are respectively provided external air guide check valves 33a and 34a, which close the external air guide channels 25a and 26a when the positive pressure check valves 31a and 32a open the positive pressure supply paths 23a and 24a and which open the external air guide channels 25a and 26a when it close the positive pressure supply paths 23a and 24a.

Thus, when the piston 13 moves leftward in FIG. 2 and the expansion-contraction chamber 21 contracts, the positive pressure check valve 31a is opened and the positive pressure air path 23a comes to a positive pressure air state, whereby positive pressure air is supplied to the operation port 5. Meanwhile, when it moves rightward, the positive pressure check valve 31a is closed and the external air guide check valve 33a is opened, whereby external air is guided from the external air guide channel 25a to the expansion-contraction chamber 21.

Similarly, when the piston 13 is moved rightward in FIG. 2 and the expansion-contraction chamber 22 contracts, the positive pressure check valve 32a is opened and the positive pressure air path 24a comes to a positive pressure air state, whereby positive pressure air is supplied to the operation port 6. Meanwhile, when it moves leftward, the positive pressure check valve 32a is closed and the external air guide check valve 34a is opened, whereby external air is guided from the external air guide channel 26a into the expansion-contraction chamber 22.

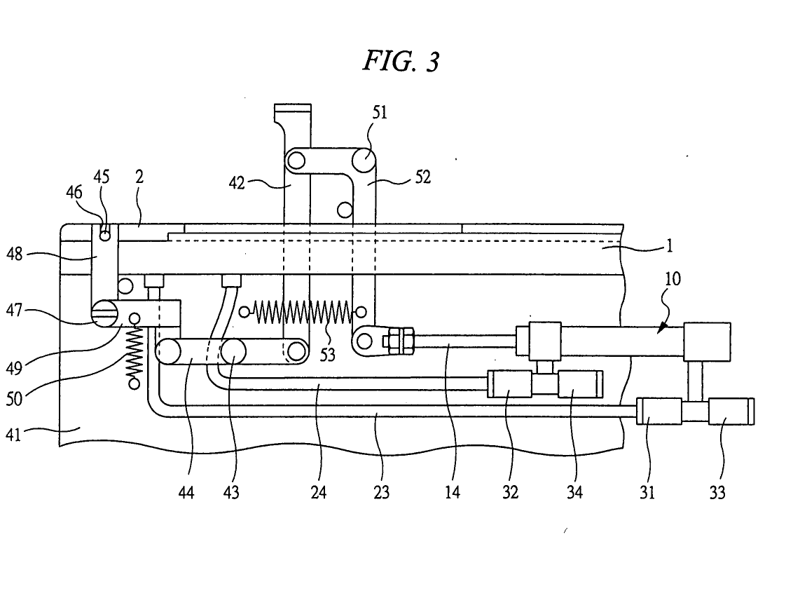

FIG. 3 is a schematic diagram of the pressure generating device which is another embodiment of the present invention. This pressure generating device is applied to the same part-conveying device as that shown in FIG. 1 so that, by supplying negative pressure air to the part-conveying device, parts can be positioned at a predetermined location and be pulled out from the head one of them to the outside. In FIG. 3, members common to those shown in FIG. 1 are denoted by the same reference numbers.

As is the case in FIG. 1, this part-conveying device is such that the part can be guided into a structural member for part path, namely, the guide rail 1 and be conveyed. The guide rail 1 is mounted in a frame 41 of the part-supplying device, and the leading portion of the guide rail 1 is provided with an open-close type shutter 2. In the frame 41 of the part-conveying device, an operation lever 42 reciprocatable vertically in FIG. 3 is installed in order to drive synchronously the shutter 2 and the piston rod 14 of the cylinder 10. The operation lever 42 is driven vertically by a not-shown driving means such as an air pressure cylinder etc.

The operation lever 42 is pin-coupled to one end portion of a shutter drive lever 44, which is swingably supported by a support shaft 43 on the frame 41 of the part-supplying device. A follower lever 48, having a slit 46 with which a coupling pin 45 fixed to the shutter 2 is engaged and being swingably mounted on the frame 41 of the part-supplying device by a support shaft 47, is pin-coupled to the other end portion of the shutter drive lever 44 through a linkage lever 49. Accordingly, when the operation lever 42 is driven downwards in FIG. 3, the shutter 2 slides leftward in FIG. 3 through the shutter drive lever 44, the linkage lever 49 and the follower lever 48, whereby a part-conveying port is opened. A spring force in the closing direction thereof is applied to the shutter 2 by a compression coil spring 50.

The frame 41 of the part-supplying device has a support axle 51 mounted on a not-shown bracket, and a cylinder drive lever 52 bent at a right angle is swingably installed to the support shaft 51. One end of the cylinder drive lever 52 is pin-coupled to the operation lever 42, and the other end thereof is pin-coupled to the piston rod 14. Thus, when the operation lever 42 is driven downward in FIG. 3, the piston rod 14 is driven rightward through the cylinder drive lever 52. A spring force for driving leftward the piston rod 14 is applied to the cylinder drive lever 52 by the compression coil spring 53, and when the downward driving to the operation lever 42 is released, the piston rod 14 is driven leftward by the spring force.

In this manner, the part-conveying device shown in FIG. 3 is such that the shutter 2 and the cylinder 10 are driven synchronously by one driving means. The negative pressure check valve 31 and 32 mounted to the cylinder 10 are respectively connected to the operation ports 5 and 6 by the negative pressure supply paths 23 and 24 as is the case in FIG. 1.

The pressure generating device shown in FIGS. 1-3 can get the piston rod reciprocating at a high speed of 0.1 second or less and generate pulsed compressed air or negative pressure air. The used parts are extremely small and light parts such as rectangular electronic parts with a size of 1.0×0.5 mm or 0.6×0.3 mm, and can be certainly positioned at the predetermined location of the part-conveying device, by means of the suction and exhaust by the air pressure cylinder 10, so that the parts can be pulled out certainly.

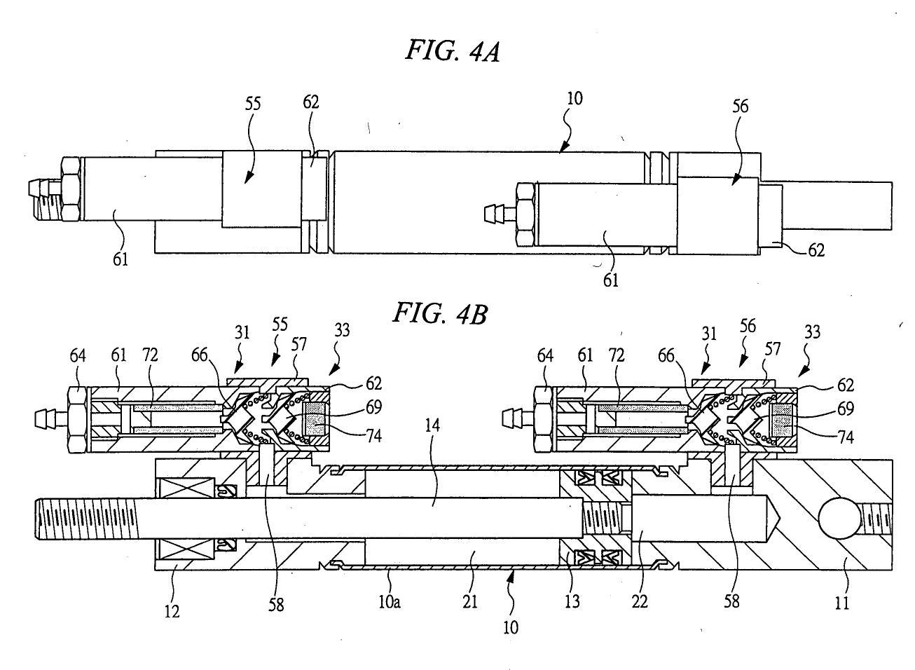

FIG. 4A is a plan view showing the detailed structure of the pressure generating device shown in FIG. 1, and FIG. 4B is a cross-sectional view of FIG. 4A. The cylinder 10 is constituted from a cylinder tube 10a, to both ends of which a head cover 11 and a rod cover 12 are respectively fixed. Check valve assemblies 55 and 56 are mounted on the head cover 11 and the rod cover 12, respectively.

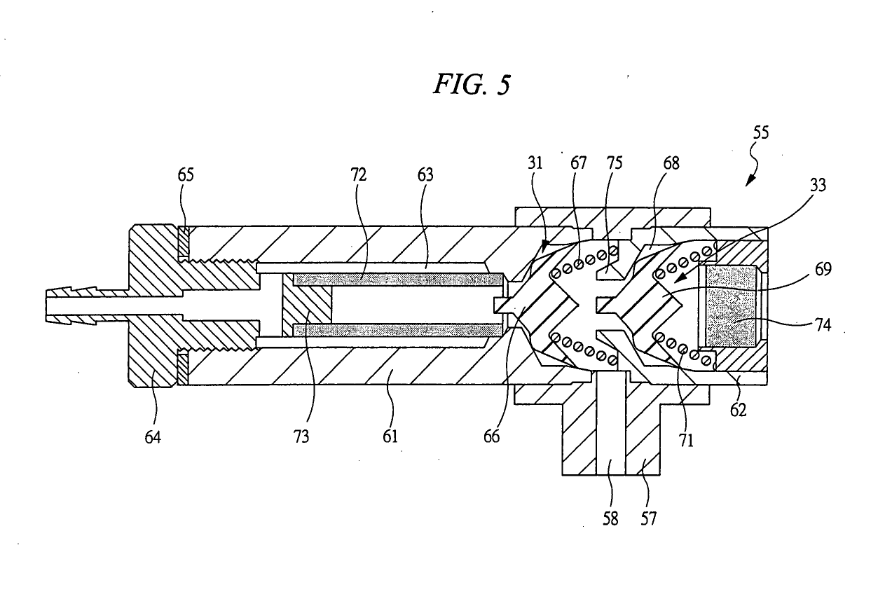

An enlarged view of the check valve assembly 55 is shown in FIG. 5, and the check valve assembly 56 also has the same structure. The check valve assembly 55 has a mounting member 57 fixed to the rod cover 12, and two hollow members 61 and 62 are installed to the mounting member 57. In the hollow member 61, there is formed a channel 63, which passes through the inside thereof and communicates with a communication path 58 formed in the mounting member 57, and a joint member 64 is screwed at the tip thereof so that the joint member 64 is connected to the operation port by a not-shown tube constituting the negative pressure supply path 23. Note that the reference symbol “65” denotes a gasket.

The rear end of the hollow member 61 is provided with a valve element 66 comprising an elastic body made of rubber etc., which constitutes the negative pressure check valve 31, and a spring force, exerted in the closing direction of the channel 63 by the spring member 67, is applied to the valve element 66. In the hollow member 62, a channel 68 for communicating with the communication path 58 and the outside is formed, and there is provided a rubber valve element 69 constituting the exhaust check valve 33. A spring force, exerted in the closing direction of the channel 68 by the spring member 71, is applied to the valve element 69.

Thus, when air flows from the channel 63 to the communication path 58, the valve element 66 serving as the negative pressure check valve 31 opens, whereby reverse flow thereto is blocked by the valve element 66. Meanwhile, when air flows from the communication path 58 to the channel 68, the valve element 69 serving as the exhaust check valve 33 opens, whereby reverse flow thereto is blocked by the valve element 69.

A filter 72, formed of a porous material and into a cylinder, is incorporated in the hollow member 61, and the end of the joint-member side of the filter 72 is closed by a cover member 73. Thus, when air flows through the channel 63, foreign matters such as dust etc. included in the inside thereof are captured by the filter 72. Similarly, a filter 74, formed of a porous material and into a cylinder, is incorporated in the end of the hollow member 62, whereby foreign matters in the air discharged into the outside are removed by the filter 74 and the filter 74 functions also as a muffler for reducing exhaust sound.

In the pressure generating device having the above-described structure, when the piston rod 14 is reciprocated linearly, the operation port 5 comes to a negative pressure state if the piston rod 14 backs rightward in FIGS. 1 and 4 and no negative pressure is supplied to the operation port 5 if the piston 14 advances leftward. Similarly, no negative pressure air is supplied to the operation port 6 if it is backed rightward, and the operation port 6 comes to a negative pressure state if it is advanced leftward. Thereby, pulsed negative pressure air is supplied to each of the operating ports 5 and 6 and, by continuously reciprocating the piston rod 14, the supply and the supply-stop of the pulsed negative pressure air into each of the operating ports 5 and 6 is repeated.

As shown in FIG. 5, a protrusion 75, protruding toward the valve element 66, is formed at the hollow member 62. Accordingly, when the expansion-contraction chamber expands and air flows from the channel 63 toward the expansion-contraction chamber, the air comes to flow along the outer circumferential surface of the valve element 66. The air flows into the expansion-contraction chamber, without an influence of the valve element 66 on the valve element 69 by the protrusion 75. Thus, even if the interval between the valve elements is not enlarged due to the protrusion 75, the influence of the air on the valve element 69 is prevented, thereby allowing for achieving easily the miniaturization of the check valve assembly. This flow of the air certainly generates a suction stream with a predetermined degree of vacuum, thereby functioning to prevent reverse flow of the air and allowing certainly a predetermined amount of negative pressure air to influence the part.

Conversely, when the expansion-contraction chamber contracts, the air flowing therefrom hits the protrusion 75 to influence the valve element 66 in the closing direction thereof and influence the valve element 69 so as to be opened against the spring force. Thus, the flow of the air functions to securely seal the valve element 69, thereby allowing for achieving the certain switch of the suction and exhaust of the air.

Thereby, as shown in FIG. 1, when the respective negative pressure supply paths 23 and 24 are connected to the part-discharge port of the guide rail 1 of the bulk feeder, the supply and the supply-stop of the negative pressure air are repeated pulsedly and thus the part W, which is conveyed at the part-discharge port 3, is instantaneously pulled onto the bottom surface of the guide rail 1 to be positioned at the predetermined location in the predetermined posture.

Additionally, since the supply and the supply-stop of the negative pressure air is repeated, the suction-attachment member 4 can get the part W smoothly rising and being conveyed when the part W is got rising under the state of the supply-stop of the negative pressure air in suction-attaching the part W to the suction-attachment member 4 by vacuum. Note that one of the two operation ports 5 and 6 may be provided on a sidewall of the guide rail 1.

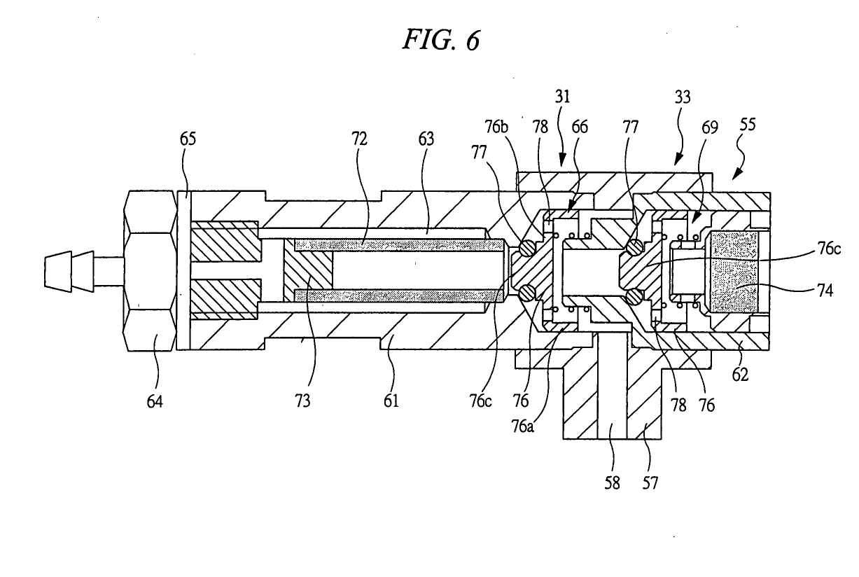

FIG. 6 is a cross-sectional view of a modified example of the check valve assembly 55, and this check valve assembly 55 has the same structure as that of FIG. 5 except each of the valve elements 66 and 69. The valve elements 66 and 69 are constituted from a valve body 76 and an O-ring portion 77 although those shown in FIG. 5 are an integrated valve formed of an elastic body such as rubber etc. The valve body 76 has a cylinder portion 76a and an end plate 76b. A protrusion 76c for supporting the O-ring portion 77 is provided on the end plate 76b, and an air hole 78 is formed therein.

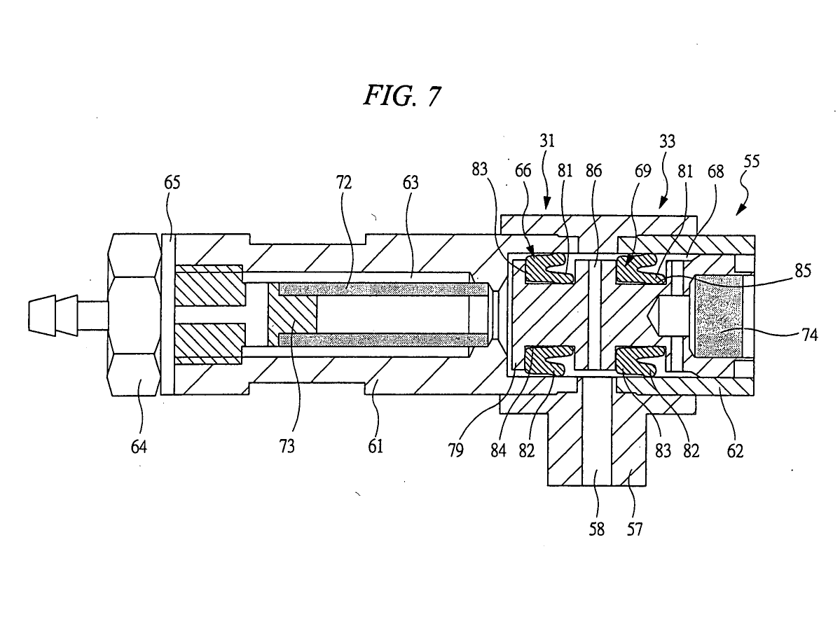

FIG. 7 is a cross-sectional view of another modified example of the check valve assembly 55. Each of the valve elements 66 and 69 in the check valve assembly 55 is formed of a seal material comprising an elastic body of rubber etc., which is installed in a core 79 mounted in the hollow member 62. Each of the valve elements 66 and 69 has an inner circumferential portion 81, an outer circumferential portion 82, and a diametric portion 83 provided between these portions, and is formed in a U-shape in section. The valve elements 66 and 69 are fixed to circular grooves 84 and 85 formed in the core 79, respectively. An air hole 86 penetrating diametrically is formed in the core 79, whereby the air from the channel 63 toward the expansion-contraction chamber flows outside the outer circumferential portion 82 of the valve element 66 and the air from the expansion-contraction chamber toward the channel 68 flows outside the-outer circumference portion 82 of the valve element 69.

FIGS. 6 and 7 each are a modified example of the check valve assembly 55, but the check valve assembly 56 also has the same structure.

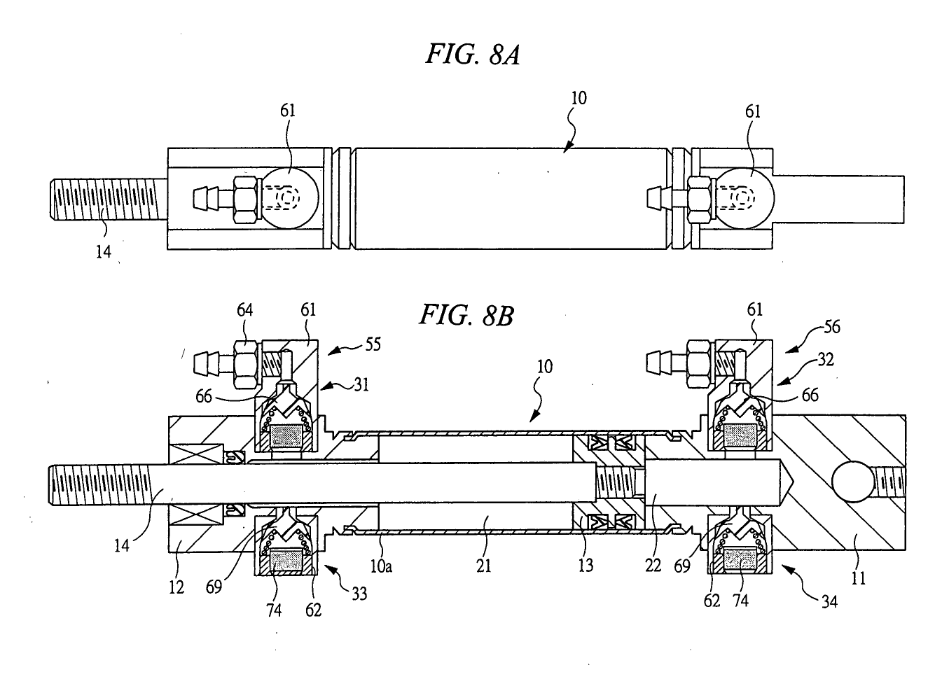

FIG. 8A is a plan view showing a modified example of the cylinder 10, and FIG. 8B is a cross-section view of FIG. 8A, and both figures show a portion corresponding to FIG. 4, respectively. In the cylinder 10 shown in FIG. 8, the hollow member 61 for accommodating the valve element 66, and the hollow member 62 for accommodating the valve element 69 are separated, and are mounted on the cylinder 10 so as to face each other at a 180 degrees phase with respect to the central axial of the cylinder 10. The respective structures of the valve elements 66 and 69 are the same as those shown in FIG. 4.

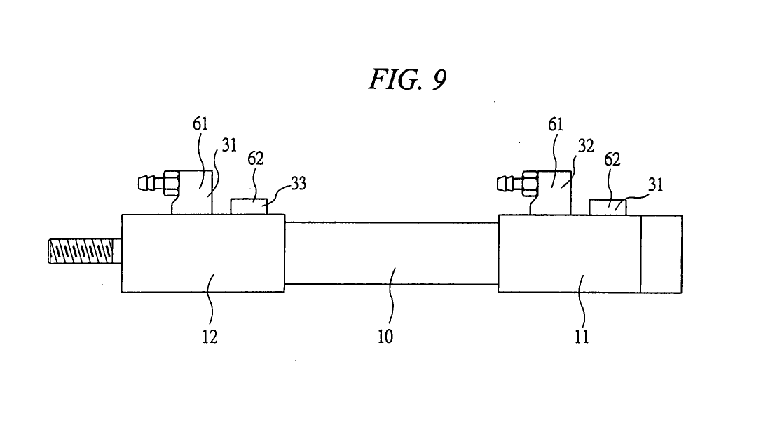

FIG. 9 is a front view of yet another modified example of the cylinder 10 and, in this case, the check valves shown in FIG. 8 are disposed so as to be adjacent thereto.

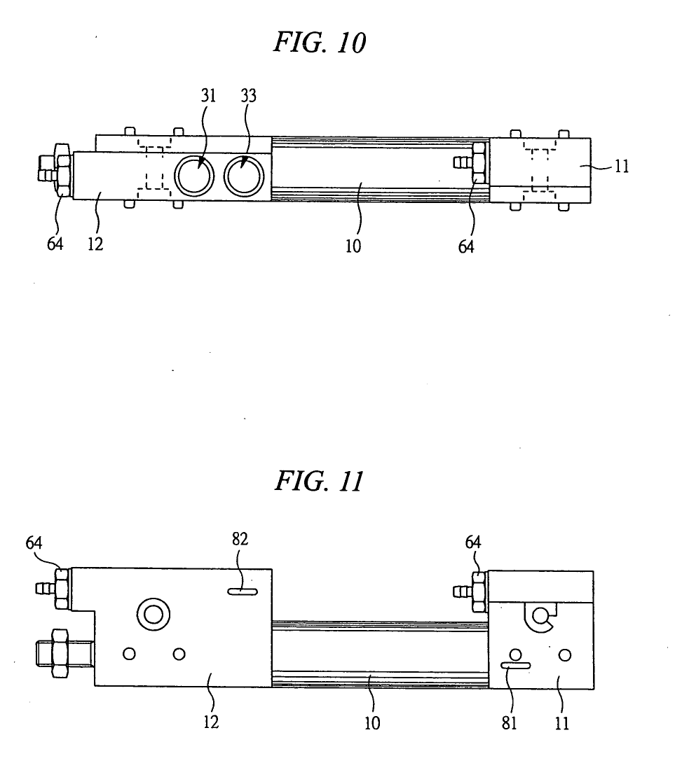

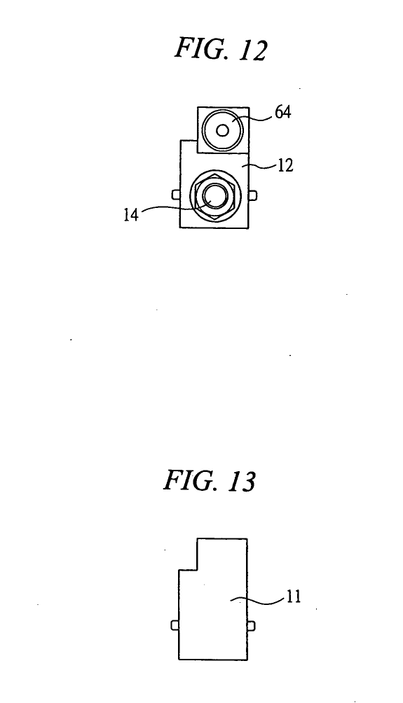

FIGS. 10 to 14 show yet other modified examples of the pressure generating device. In the head cover 11 mounted on one end of the cylinder 10, a negative pressure check valve 32, an exhaust check valve 34, and a filter 72 are incorporated. In the rod cover 12 mounted to the other end of the cylinder 10, a negative pressure check valve 31, an exhaust check valve 33, and a filter 72 are incorporated.

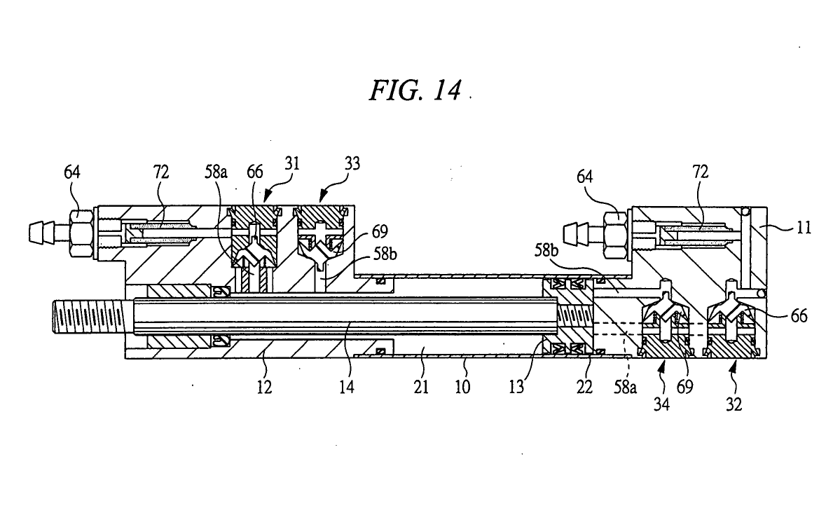

The negative pressure check valve 32 has a valve element 66 for opening and closing a communication path 58a communicating with the expansion-contraction chamber 22 and the joint member 64. The valve element 66 allows air to flow into the expansion-contraction chamber 22 when the piston rod 14 advances leftward in FIG. 14, and blocks flow of air into the joint member 64 from the expansion-contraction chamber 22 when the piston rod 14 backs. As shown in FIG. 11, the exhaust check valve 34 has the valve element 69 for opening and closing the communication path 58b communicating with an exhaust hole 81 and the expansion-contraction chamber 22. This valve element 69 allows the flow of air from the expansion-contraction chamber 22 into a discharge hole 81 when the piston rod 14 backs rightward in FIG. 14, and blocks the flow of air from the discharge hole 81 into the expansion-contraction chamber 22 when the piston rod 14 advances leftward.

The negative pressure check valve 31 has the valve element 66 for opening and closing a communication path 58a communicating with the expansion-contraction chamber 21 and the joint member 64. This valve element 66 allows air to flow into the expansion-contraction chamber 21 when the piston rod 14 backs rightward in FIG. 14, and blocks the flow of air from the expansion-contraction chamber 21 into the joint member 64 when the piston rod 14 advances. As shown in FIG. 11, the exhaust check valve 33 has the valve element 69 for opening and closing a communication path 58b communicating with the exhaust hole 82 and the expansion-contraction chamber 21. This valve element 69 allows the flow of air from the expansion-contraction chamber 21 into the exhaust hole 82 when the piston rod 14 advances leftward in FIG. 14, and blocks the flow of air from the discharge hole 82 into the expansion-contraction chamber 21 when the piston rod 14 backs rightward.

The present invention is not limited to the aforementioned embodiments, and can be variously modified and changed without departing from the gist thereof. For example, in the pressure generating device in the drawings, the expansion-contraction chambers in both sides of the piston 13 are connected to the operation ports, but only one of the expansion-contraction chambers may be connected to the operation port. Also, by connecting one of both pressure supply paths to the other, positive pressure or negative pressure air may be supplied to the same operation port at the time of both advance and back of the piston 13. In that case, positive pressure or negative pressure air having not a pulse but a smoothed predetermined pressure may be constantly supplied to the operation port. Further, the conveying device for loading the part W on the mounting substrate is applied to the case of illustration, but may be applied to the case of being mounted on a test port. Also, the negative pressure supply into the suction-attachment member 4 shown in FIG. 1 may be supplied by this pressure generating device. Further, the pressure supply device of the present invention is not limited to application to the above cases, and can be applied even to any cases if the supply of negative or positive pressure is required.

### Industrial Applicability

The pressure generating device of the present invention can be used for generating pulsed negative pressure air or positive pressure air.

1. A pressure generating device comprising:
a cylinder for accommodating axially and reciprocatably a piston fixed to a piston rod;
a driving means linked to said piston rod and reciprocating-driving said piston axially;
a pressure supply path connecting a expansion-contraction chamber formed in said cylinder, and an operation port to which positive pressure or negative pressure air is supplied;
a release check valve provided in said pressure supply path and communicating with said operation port and said expansion-contraction chamber through said pressure supply path when said expansion-contraction chamber expands and contracts depending on the reciprocating of said piston; and
an auxiliary check valve provided in an auxiliary channel connected to said pressure supply path, and closing said auxiliary channel when said release check valve opens said pressure supply path, and opening said auxiliary channel when said pressure supply path is closed,
wherein said expansion-contraction chamber is expanded by said piston to supply the positive pressure or negative pressure air to said operation port.

2. The pressure generating device having a piston and piston rod driven axially in reciprocating relationship within a cylinder, the piston forming within the cylinder at one and an opposite side of the piston expansion-contraction chambers, the improvement comprising:
a first release check valve provided in a first pressure supply path leading to a first operation port remote from the cylinder and connected to the expansion-contraction chamber at the one side of said piston;
a first auxiliary check valve provided in a first auxiliary channel connected to said first pressure supply path;
a second release check valve provided in a second pressure supply path connected to the expansion-contraction chamber at the opposite side of said piston and leading to a second operation port remote from the cylinder; and
a second auxiliary check valve provided in a second auxiliary channel connected to said second pressure supply path,
wherein by the reciprocating of said piston, air pressure from the expansion-retraction chambers is alternately supplied, to the two operation ports to which said pressure supply paths are connected.

3. The pressure generating device according to claim 1, wherein said pressure supply path is connected to said operation port formed in a part-conveying portion for conveying a part.

4. The pressure generating device according to claim 2, wherein there are provided, remote from the reciprocating piston, a first check valve assembly including said first release check valve and said first auxiliary check valve, and a second check valve assembly including said second release check valve and said second auxiliary check valve.

5. The pressure generating device of claim 2 wherein the first release check valve and the first auxiliary check valve are arranged relative to the first pressure supply path to provide negative air pressure to the operation port of the first supply path.

6. The pressure generating device of claim 5 wherein the second release check valve and the second auxiliary check valve are arranged relative to the second pressure supply path to provide negative air pressure to the operation port of the second supply path.

7. The pressure generating device of claim 2 wherein the first release check valve and the first auxiliary check valve are arranged relative to the first pressure supply path to provide positive air pressure to the operation port of the first supply path.

8. The pressure generating device of claim 7 wherein the second release check valve and the second auxiliary check valve are arranged relative to the second pressure supply path to provide negative air pressure to the operation port of the second supply path.
